(19) United States
(12) Patent Application Publication
(10) Pub. No.: US 2025/0272850 A1
(43) Pub. Date: Aug. 28, 2025

(54) IMAGE GENERATION METHOD, CAMERA DEVICE AND COMPUTER-READABLE STORAGE MEDIUM

(71) Applicant: Shenzhen Reolink Technology Co, Ltd., Shenzhen (CN)

(72) Inventors: Guixing Wang, Shenzhen (CN); Zhitao Yuan, Shenzhen (CN); Xing Xu, Shenzhen (CN)

(21) Appl. No.: 19/206,284

(22) Filed: May 13, 2025

(30) Foreign Application Priority Data
May 13, 2024 (CN) 202410591309.6

(51) Int. Cl. G06T 7/194; G06V 20/52

(52) U.S. Cl. CPC G06T 7/194; G06V 20/52

(57) ABSTRACT

The present application provides an image generation method, a camera device and a computer-readable storage medium. The method including: acquiring a background image and monitored images, each of the monitored images containing a monitored target; obtaining a plurality of sub-images based on a region in each of the plurality of monitored images, the region comprising the monitored target being a portion of each of the monitored images; and generating an image by putting at least two of the sub-images in the background image in a chronological order. By implementing of the above-mentioned method, the monitored target information about an alarm event can be quickly and completely browsed for a user.

### TECHNICAL FIELD

Embodiments of the present application relate to the technical field of monitored image processing, and in particular, to an image generation method, a camera device and a computer-readable storage medium.

### BACKGROUND

With popularity of cameras, particularly home cameras, in order to effectively monitor home security, many users choose to install the camera indoors or outdoors in order to be able to capture any security threats that may occur. These cameras are typically arranged to trigger an alarm when a preset monitored target is detected, and to generate a corresponding video clip.

In order to improve the efficiency of dealing with alarm events, a series of methods have been adopted in the industry. For example, a monitored image of a frame within an alarm event is saved as a screenshot of the alarm event and the screenshot of the alarm event is provided to the user, or a video clip of the alarm is intercepted and the intercepted clip is set to be played at double speed for the user to browse quickly. However, although the alarm event screenshot is convenient to preview, the user can only be provided with preset monitored target information in a certain moment monitored region, and the amount of information provided to the user in this way is too small; playing the alarm video clips at double speed only fast forwards the alarm clips, and even though the user can learn the information of the whole event, it still takes a lot of time.

Therefore, how to enable a user to quickly and completely browse the preset monitored target information of the alarm event becomes an urgent technical problem to be solved.

### SUMMARY

According to an aspect of the present application, an image generation method is provided, which includes: acquiring a background image and a plurality of monitored images arranged by a time sequence, where at least some of the monitored images contain a preset monitored target; determining the monitored image comprising the preset monitored target of the plurality of monitored images as a monitored image to be processed; performing a pasting step on the plurality of monitored images to be processed successively according to the time sequence of the monitored images to be processed, where the pasting step includes: intercepting a region comprising the preset monitored target in the monitored image to be processed as a sub-image to be pasted; judging whether the monitored image to be processed is a first image of the plurality of monitored images to be processed and whether a pasted sub-image exists in the background image; if the monitored image to be processed is a first image of the plurality of monitored images to be processed and the pasted sub-image does not exist in the background image, pasting the sub-image to be pasted of the first image into the background image; if the monitored image to be processed is not the first image or the pasted sub-image exists in the background image, determining a current pasting range of the sub-image to be pasted in the background image according to a position of the sub-image to be pasted in the monitored image to be processed and a size of the sub-image to be pasted; judging whether the current pasting range overlaps with a pasting range of a pasted sub-image in the background image; if the current pasting range does not overlap with the pasting range of the pasted sub-image in the background image, pasting the sub-image to be pasted to the current pasting range of the background image; and after performing the pasting step on the plurality of monitored images to be processed, determining the obtained background image as an image required to be generated.

In an alternative, after the if the current pasting range does not overlap with the pasting range of the pasted sub-image in the background image, pasting the sub-image to be pasted to the current pasting range of the background image, the pasting step further includes: determining a first peripheral region of the sub-image to be pasted in the monitored image to be processed, and determining a first pixel value of the first peripheral region in the monitored image to be processed, where the first peripheral region is an extended region outside a boundary of the sub-image to be pasted; determining a second peripheral region of the sub-image to be pasted in the background image, and determining a second pixel value of the second peripheral region in the background image, where the second peripheral region is the extended region outside the boundary of the sub-image to be pasted, and a shape and a size of the first peripheral region and the second peripheral region are the same; determining a third pixel value according to the first pixel value and the second pixel value; and filling the second peripheral region with the third pixel value.

In an alternative, the determining a first peripheral region of the sub-image to be pasted in the monitored image to be processed, and determining a first pixel value of the first peripheral region in the monitored image to be processed includes: determining the first peripheral region of the sub-image to be pasted in the monitored image to be processed, and randomly selecting a first color taking point in the first peripheral region; determining a pixel value of the first color taking point as the first pixel value; the determining a second peripheral region of the sub-image to be pasted in the background image, and determining a second pixel value of the second peripheral region in the background image includes: determining the second peripheral region of the sub-image to be pasted in the background image, and selecting a second color taking point in the second peripheral region according to the position of the first color taking point in the first peripheral region; and determining a pixel value of the second color taking point as the second pixel value.

In an alternative, the determining a third pixel value according to the first pixel value and the second pixel value includes: determining a first weighted value and a second weighted value of each pixel point in the second peripheral region according to a distance value from the each pixel point to the boundary of the sub-image to be pasted, where the first weighted value of the each pixel point is negatively correlated with the second weighted value, and the first weighted value of the each pixel point is negatively correlated with the distance value; determining a sum value between a product of the first weighted value and the first pixel value and a product of the second weighted value and the second pixel value of each pixel point as a third pixel value of each pixel point; the filling the second peripheral region with the third pixel value includes: filling each pixel point in the second peripheral region in the background image with the third pixel value of the each pixel point.

In an alternative, the current pasting range and the pasting range of the pasted sub-image in the background image are both rectangular regions, and the judging whether the current pasting range overlaps with a pasting range of a pasted sub-image in the background image includes: determining a width w of the overlapped region according to a formula w=min {Ax₂, Bx₂}−max {Ax₁, Bx₁}, and determining a height h of the overlapped region according to a formula h=min {Ay₁, By₁}−max {Ay₂, By₂}, where (Ax₁, Ay₁) and (Ax₂, Ay₂) are respectively vertex coordinates of an upper left corner and vertex coordinates of a lower right corner of the current pasting range, and (Bx₁, By₁) and (Bx₂, By₂) are respectively the vertex coordinates of the upper left corner and the vertex coordinates of the lower right corner of the pasting range of the pasted sub-image in the background image; judging whether the width is greater than 0 and whether the height is greater than 0; if the width is not greater than 0 or the height is not greater than 0, determining that the current pasting range does not overlap with the pasting range of the pasted sub-image in the background image; and if the width is greater than 0 and the height is greater than 0, determining that the current pasting range overlaps with the pasting range of the pasted sub-image in the background image.

In an alternative, if at least one monitored image of the plurality of monitored images comprises a plurality of preset monitored targets, the step of performing a pasting step on the plurality of monitored images to be processed successively according to the time sequence of the monitored images to be processed includes: performing the pasting step on each monitored image to be processed comprising the same preset monitored target of the plurality of monitored images to be processed successively according to the time sequence of the monitored images to be processed; the intercepting a region comprising the preset monitored target in the monitored image to be processed as a sub-image to be pasted includes: intercepting a region comprising a same preset monitored target in the monitored image to be processed as a sub-image to be pasted.

In an alternative, the acquiring a background image and a plurality of monitored images arranged by a time sequence includes: in response to recognizing the preset monitored target appearing in the monitored region, acquiring the plurality of monitored images continuously captured with respect to the monitored region within a preset time period, and acquiring the background image; or, in response to recognizing the preset monitored target appearing in the monitored region, acquiring a plurality of monitored images from a time period when the preset monitored target appearing in the monitored region to when the preset monitored target disappears from the monitored region, and acquiring the background image.

In an alternative, the acquiring a background image and a plurality of monitored images arranged by a time sequence includes: acquiring the plurality of monitored images arranged by the time sequence; and converting one monitored image of the plurality of monitored images from an RGB color space to a YUV color space, and determining the converted image as the background image.

According to another aspect of the present application, a camera device is provided, which includes a memory, a processor and a computer program stored on the memory, where the processor executes the computer program to implement the image generation method according to any one of the above.

According to another aspect of the present application, a computer-readable storage medium is provided, which has stored thereon a computer program, where the computer program, when executed by a processor, implements the image generation method according to any one of the above.

In the present application, according to the size of each sub-image to be pasted and the position in each monitored image to be processed, the sub-image to be pasted is pasted into the same background image, so that the background image (namely, an alarm event paste) obtained after executing the pasting step displays the same preset monitored target at different positions, and a moving track of the preset monitored target can be indicated, thereby enabling a user to learn preset monitored target information including the preset monitored target and the moving track thereof in a monitored region via the alarm event paste; since such preset monitored target information essentially comprises information that the preset monitored target is within a certain period of time rather than at a certain moment, the user can completely know the preset monitored target information of the alarm event. By browsing one alarm event paste, the complete preset monitored target information can be known, the browsing time is reduced, and the fast browsing can be achieved.

Further, if the sub-image to be pasted comprising the preset monitored target is directly pasted to the background image according to the position of the sub-image to be pasted in the to-be-monitored image, there will be a case where a plurality of pasted sub-images overlap in the background image, and if the display is confused due to the overlapping of the plurality of pasted sub-images, the user's requirement of quickly and completely browsing the preset monitored target information of the alarm event will also not be met; therefore, before the sub-image to be pasted is pasted to the background image, according to the position of the sub-image to be pasted in the monitored image to be processed and the size of the sub-image to be pasted, the current pasting range of the sub-image to be pasted in the background image is determined, and only when the current pasting range does not overlap with the pasting range of the pasted sub-image in the background image, the sub-image to be pasted is pasted, so as to avoid the case where the preset monitored target display is confused due to the overlapping of the sub-image to be pasted on the background image and the pasted sub-image.

The camera device and the computer-readable storage medium provided in the present application all have the same advantages as the above-mentioned image generation method with respect to the prior art, which is not repeated here.

The above description is merely an overview of the technical solution of the embodiments of the present application, which can be implemented according to the contents of the description in order to enable the technical means of the embodiments of the present application to be more clearly understood, and in order to enable the above and other targets, features and advantages of the embodiments of the present application to be more clearly understood, particular embodiments of the present application are set forth below.

### BRIEF DESCRIPTION OF THE DRAWINGS

The drawings are only for purposes of illustrating the embodiments and are not to be construed as limiting the present application. Moreover, like reference numerals designate like parts throughout the several views. In the drawings:

FIG. 1 is a schematic diagram showing an application scenario according to an embodiment of the present application;

FIG. 2 is a schematic structural diagram showing a camera device according to an embodiment of the present application;

FIG. 3 is a schematic flow diagram showing an image generation method according to an embodiment of the present application;

FIG. 4 is a schematic flow diagram showing steps of pasting according to an embodiment of the present application;

FIG. 5 is a schematic diagram showing a background image obtained through a step of pasting according to an embodiment of the present application;

FIG. 6 is a schematic flow diagram showing intersection determination steps according to an embodiment of the present application;

FIG. 7 is a schematic diagram showing an overlapped region of a sub-image to be pasted and a pasted sub-image according to an embodiment of the present application;

FIG. 8 is a schematic diagram showing a first outer peripheral region and a second outer peripheral region according to an embodiment of the present application.

### DETAILED DESCRIPTION

Hereinafter, example embodiments of the present application will be described in more detail referring to the accompanying drawings. While example embodiments of the present application are illustrated in the drawings, it should be understood that the present application may be embodied in various forms and should not be limited to the embodiments set forth herein.

FIG. 1 is a schematic diagram showing an application scenario according to an embodiment of the present application; as shown in FIG. 1, the image generation method provided by the present application is applied to a camera device 1. The camera device 1 establishes a communication connection with a terminal device 2 via a network 3. The camera device 1 may be a video camera for security monitoring, an IP camera or other video monitoring devices. The terminal device 2 can be a touch control type mobile phone, an intelligent mobile phone, a tablet computer, a portable terminal device or other terminal electronic devices with a display screen. The network 3 includes, but is not limited to, one or more of a local region network (LAN), a metropolitan region network (MAN), a wide region network (WAN), a 4G/5G network, a WIFI, a Bluetooth, and a point-to-point (P2P) communication network.

In the embodiment of the present application, the camera device 1 and the terminal device 2 may each include one or more processors, which may be a Central Processing Unit (CPU), or an Application Specific Integrated Circuit (ASIC), or one or more integrated circuits configured to implement the embodiment, and are not limited thereto. One or more processors included in the terminal device may be the same type of processor, such as one or more CPUs; it may also be a different type of processor, such as one or more CPUs and one or more ASICs, which is not limited herein.

In the embodiment of the present application, the camera device 1 is installed in a region to be monitored (e.g., home, office, shopping mall, etc.) so that the camera device 1 can continuously take a monitoring video in the monitored region and transmit the monitoring video to the terminal device 2 of the terminal via the network 3 for the user to browse.

After recognizing a preset monitored target, the camera device 1 generates an alarm event paste and stores same, and when a user views an alarm event via the terminal device 2, the terminal device 2 generates a viewing instruction according to a selection of the user and sends same to the camera device 1, and the camera device 1 sends the alarm event paste to the terminal device 2 for the user to view.

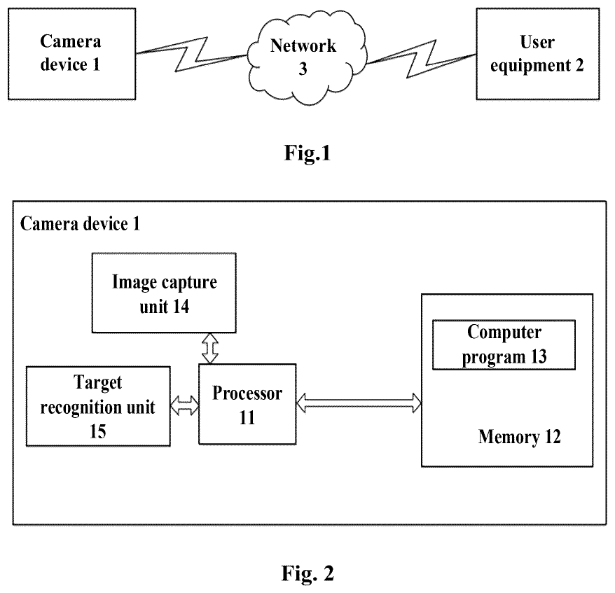

FIG. 2 is a schematic structural diagram showing a camera device according to an embodiment of the present application. As shown in FIG. 2, the camera device 1 may include: a processor 11 and a memory 12.

The processor 11 is configured to execute a computer program 13, which in particular may perform the relevant steps in the embodiments of the image generation method provided in the present application. In particular, the computer program 13 may include computer-executable instructions.

The processor 11 may be a central processing unit CPU, or an Application Specific Integrated Circuit (ASIC), or one or more integrated circuits configured to implement the embodiments of the present application. The one or more processors included in the camera device 1 may be the same type of processors, such as one or more CPUs or may also be different types of processor, such as one or more CPUs and one or more ASICs.

The memory 12 is configured to store a computer program 13. The memory 12 may include high-speed RAM memory, and may also include non-volatile memory, such as at least one disk memory.

In the embodiment of the present application, the camera device 1 further includes an image capture unit 14 and a target recognition unit 15. The image capture unit 14 is configured to shoot and record the monitored region. The target recognition unit 15 is configured to require a shot image from the image capture unit 14, and run a target recognition algorithm to recognize whether a preset monitored target of interest appears on the image, such as a person, an animal, a vehicle, etc. and if it is recognized that the preset monitored target of interest appears on the image, triggering an alarm. The target recognition algorithm can be a You Only Look Once (YOLO) algorithm, YOLO is one real-time target detection algorithm, which transforms a target detection problem into a regression problem, and predicts a bounding box and class probability through a single forward propagation. It may also be a Faster R-CNN (Fast R-CNN) algorithm, the Faster R-CNN is an improved version of a region-based convolution neural network (R-CNN), which introduces a region proposal network (RPN) to generate candidate regions, thus improving the detection speed; it may also be a CenterNet algorithm, the CenterNet is a target detection algorithm based on center point detection, which uses key point detection to locate a center point of an object, and generates the bounding box through feature prediction. The target recognition algorithm can be selected according to actual usage requirements, which is not particularly limited in the embodiments of the present application. The target recognition unit 15 may employ an Artificial Intelligence (AI) chip.

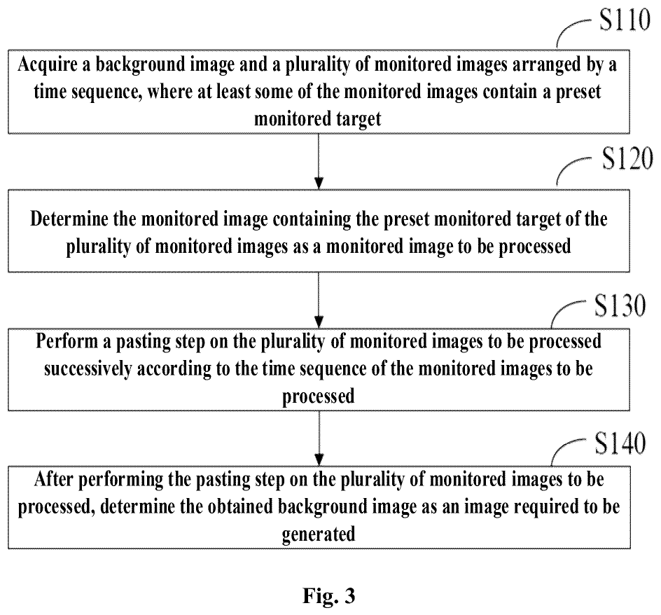

FIG. 3 is a schematic flow diagram showing an image generation method according to an embodiment of the present application, and the method is performed by the camera device 1. As shown in FIG. 3, the process includes the steps of:

S110 Acquire a background image and a plurality of monitored images arranged by a time sequence, where at least some of the monitored images contain a preset monitored target.

The camera device 1 performs real-time monitoring on the monitored region. The image capture unit 14 acquires images continuously from the monitored region to obtain a plurality of monitored images, and the target recognition unit 15 acquires the monitored images from the image capture unit 14 and recognizes a preset monitored target. When the target recognition unit 15 recognizes a preset monitored target in the monitored image, the target recognition unit 15 triggers an alarm event. The preset monitored target may be a person, an animal, a vehicle, or the like. If the monitored target has acquired a permission, the monitored target is not a preset monitored target, and if the human face of the family member has been input into a permission database, the family member appears in the monitored image and does not cause the target recognition unit 15 to trigger an alarm event; if a certain license plate number has been entered into the permission database, the appearance of a vehicle of that license plate number in the monitored image does not cause the target recognition unit 15 to trigger the alarm event.

When the preset monitored target appears in the monitored region, the target recognition unit 15 triggers an alarm event until the preset monitored target disappears in the monitored region (the target recognition unit 15 does not recognize the preset monitored target in a continuous plurality of monitored images), the target recognition unit 15 stops triggering the alarm event, and in this period of time, the images capture by the image capture unit 14 are a plurality of monitored images corresponding to the alarm event.

When executing S110 acquiring a plurality of monitored images, in an alternative, S110 includes:

S111 In response to recognizing the preset monitored target appearing in the monitored region, acquire a plurality of monitored images from a time period when the preset monitored target appearing in the monitored region to when the preset monitored target disappears from the monitored region, and acquiring the background image.

Acquiring a plurality of monitored images refers to capturing a plurality of monitored pictures associated with an alarm event during the alarm event. This may include acquiring all monitored images associated with a single alarm event, or may include extracting images from all monitored images associated with a single alarm event at set frame rate intervals, e.g., if 10 monitored images are generated for a single alarm event, an option may be to acquire images for all odd frames, i.e., the first frame, the third frame, etc.

Through S111, it can be ensured that the entire active period of the preset monitored target in the monitored region is completely recorded, and the acquired monitored image includes a complete picture of the appearance and disappearance of the target in the monitored region. This comprehensive record provides much data support for subsequent target identification, behavior analysis and event backtracking.

When executing S110 acquiring a plurality of monitored images, in an alternative, S110 includes:

S113 In response to recognizing the preset monitored target appearing in the monitored region, acquire the plurality of monitored images continuously captured with respect to the monitored region within a preset time period, and acquiring the background image.

When the preset monitored target has a longer residence time in the monitored region, the duration of the generated alarm event will also be longer, and the corresponding number of monitored images will also increase. When the camera device 1 processes these monitored images associated with alarm events, the amount of data that needs to be processed is large. In order to process these data more efficiently, a preset time period may be set, that is, only the monitored image of a preset length of time is processed at a time, for example, a 100-minute alarm event is divided into twenty 5-minute clips, and the twenty 5-minute clips are processed using the image generation method, respectively. In this way, each time the camera device 1 runs the computer program 13 corresponding to the image generation method, the amount of data required to be processed is only 5 minutes of the monitored image corresponding to the alarm event. Compared with processing the monitored image corresponding to the alarm event of 100 minutes at a time, only processing a plurality of monitored images in a preset time period can reduce the amount of data required to be processed by the computer program 13, thereby avoiding the risk of the computer program 13 being overloaded to run due to processing an excessive amount of data, and ensuring that the camera device 1 can respond to and process a large amount of monitored image data in time.

When performing S110 acquiring a background image, in an alternative, S110 includes the following sub-steps:

S112 Acquire the plurality of monitored images arranged by the time sequence.

The implementation of S112 may be referred to as the implementation of S111 or S113, which will not be described in detail herein.

S114 Convert one monitored image of the plurality of monitored images from an RGB color space to a YUV color space, and determine the converted image as the background image.

RGB color space is an additive color model based on three primary colors of red, green and blue, which is widely used in computer graphics and video display technology. In the RGB color space, each color is composed of three primary colors, Red, Green and Blue, mixed in different proportions. Each pixel value in the RGB model typically consists of three 8-bit intensity values representing the brightness levels of red, green, and blue, respectively, ranging from 0 to 255, where 0 indicates that the color component does not emit light at all, and 255 indicates the maximum brightness of the color component.

The YUV color space is a color coding method, which is mainly used for television systems and video transmission. In this color space, Y represents luminance information, while the U and V components carry color difference information. An important feature of the YUV color space is that it is compatible with black-and-white television, since the luminance information can be transmitted only by the Y-component, an image is displayed on the black-and-white television. The presence of the U and V components then allows color information to be added to the color television. The YUV color space is very common in video compression and transmission because it can effectively separate luminance information from color information, thereby reducing the amount of data while maintaining image quality.

In an alternative, the conversion process of the image from the RGB color space to the YUV color space is as follows: first, for the RGB monitored image acquired by the image capture unit 14, a weighted calculation is performed on the RGB value of each pixel to obtain a Y (luminance) component. Weight coefficients are typically determined according to a color standard, such as ITU-RBT. 601 or ITU-RBT. 709. For example, according to the ITU-RBT. 601 standard, the calculation formula of Y is: Y=0.299R+0.587G+0.114B; next, the U and V (chroma) components are calculated, which involves extracting the color difference information from the RGB values. The calculation formula for the U and V components is generally: U=B−Y; V=R−Y; finally, the resulting YUV values are normalized or quantized to suit a particular video standard or compression algorithm. In some cases, the U and V components may be further scaled or shifted.

Through the above steps, the monitored image originally represented in the RGB color space is successfully converted into the YUV color space. In the converted image, the Y component comprises luminance information, while the U and V components carry color information.

Through S114, the color coding of the monitored image is converted from the RGB format to the YUV format, and the converted image is determined as a background image, which can maintain the same size and color distribution as the original monitored image while reducing the occupation of storage space, so as to facilitate the user to correspond the region in the background image to the real monitored region.

In performing S110 acquiring the background image, there are a variety of alternatives. For example, the background image may be a blank image of the same size as the monitored image; the background image may also be a prestored image of a monitored region which is captured by the camera device and does not contain any target; the background image may also be an image of the previous frame of the trigger frame of the alarm event.

S120 Determine the monitored image containing the preset monitored target of the plurality of monitored images as a monitored image to be processed.

In an alternative method, the computer program 13 contains a target recognition algorithm, and the computer program 13 performs recognition of a preset monitored target on the monitored image, and if the monitored image does not contain the preset monitored target, a pasting step is not performed on the monitored image; if the monitored image contains a preset monitored target, same is determined as a monitored image to be processed, and the pasting step is performed on the monitored image to be processed.

In another alternative, while the image capture unit 14 captures the monitored image in real time, the target recognition unit 15 identifies in real time whether or not each frame of the monitored image contains the preset monitored target, synchronously. If the monitored image contains a preset monitored target, an alarm event will be triggered, and the target recognition unit 15 will send the monitored image containing the preset monitored target to the processor 11 in real time, and the processor 11 executes the computer program 13 to perform a pasting step on the image. If the monitored image does not contain the preset monitored target, the monitored image is not sent to the processor 11 to perform the pasting step.

S130 Perform a pasting step on the plurality of monitored images to be processed successively according to the time sequence of the monitored images to be processed.

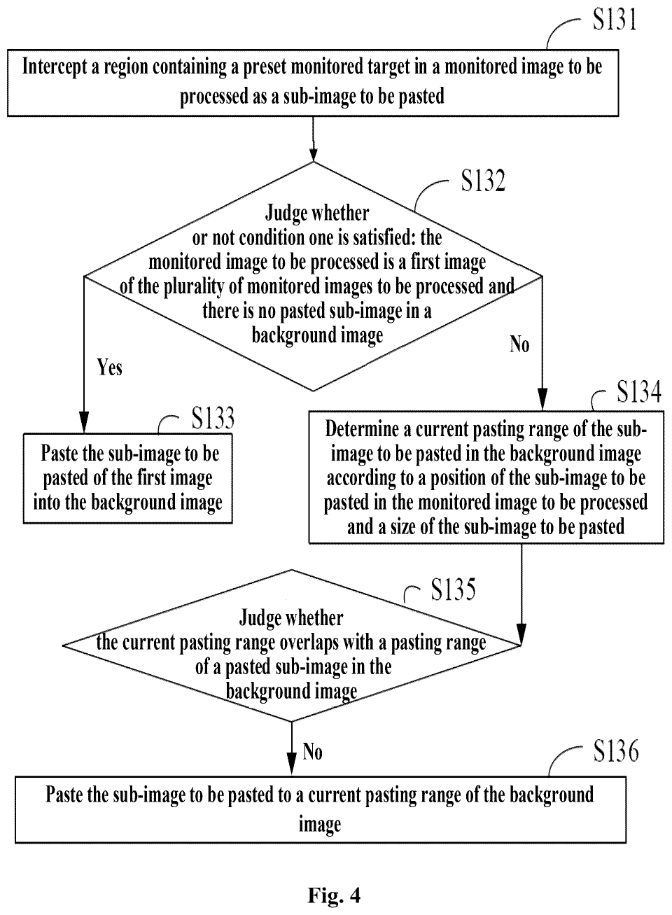

FIG. 4 is a schematic flow diagram showing steps of pasting according to an embodiment of the present application. As shown in FIG. 4, the pasting step includes:

S131 Intercept a region containing a preset monitored target in a monitored image to be processed as a sub-image to be pasted.

When the target recognition unit 15 uses a target recognition algorithm to recognize whether a preset monitored target is contained in the monitored image to be processed, a Bounding Box of the preset monitored target in the monitored image to be processed can also be located. The bounding box is a rectangular box used for recognizing a Region of Interest (ROI) in an image in image processing.

In monitored image analysis, the bounding box is used to mark and locate the preset monitored target, such as a person, an animal, or a vehicle, in an image. The generation of the bounding box usually involves the following steps: firstly, a pretrained convolution neural network or another machine learning model is used to analyze the monitored images to recognize and classify the different targets in the images. Then, once the target is identified, the target identification algorithm further performs a bounding box regression to predict the bounding box coordinates of the target, which usually includes the x and y coordinates of the upper left corner and the lower right corner of the box; finally, the bounding box is fine-tuned by the target recognition algorithm to improve its positioning accuracy and ensure that the bounding box closely surrounds the target object.

In an alternative, an image clipping algorithm may be used to clip the monitored image to be processed, and the region defined by the bounding box is clipped out to obtain a sub-image containing a preset monitored target. For example, the monitored image to be processed is clipped using cv2. clop ( ) function in an OpenCV library.

S132 Judge whether or not condition one is satisfied: the monitored image to be processed is a first image of the plurality of monitored images to be processed and there is no pasted sub-image in a background image; if the condition one is satisfied, the process proceeds to S133; if condition one is not satisfied, the process proceeds to S134.

Satisfaction of the condition one means that the monitored image to be processed is the first image of a plurality of monitored images to be processed and there is no pasted sub-image in the background image; unsatisfaction of the condition one means that the monitored image to be processed is not the first image or the pasted sub-image exists in the background image.

S133 Past the sub-image to be pasted of the first image into the background image.

In an alternative, the sub-image to be pasted of the first image is pasted into the background image, and affine transformation may be used to paste the sub-image to be pasted into the corresponding position of the background image, depending on the position of the sub-image in the first image. The affine transformation can preserve the original shape and orientation of the sub-images while allowing scaling and rotation.

After the execution of S133, the process proceeds to S131 to continue to execute the pasting step on the next monitored image to be processed located after the current monitored image to be processed.

S134 Determine a current pasting range of the sub-image to be pasted in the background image according to a position of the sub-image to be pasted in the monitored image to be processed and a size of the sub-image to be pasted.

When the sub-image to be pasted in the monitored image to be processed is pasted into the background image for subsequent processing, it may occur that the sub-image to be pasted overlaps with the pasted sub-image in the background image. This situation may cause the sub-image pasted in the previous frame to be covered by the sub-image pasted in the next frame, so that part of the sub-image in the background image is only partially displayed and cannot be completely viewed, resulting in poor display effect of the preset monitored target information.

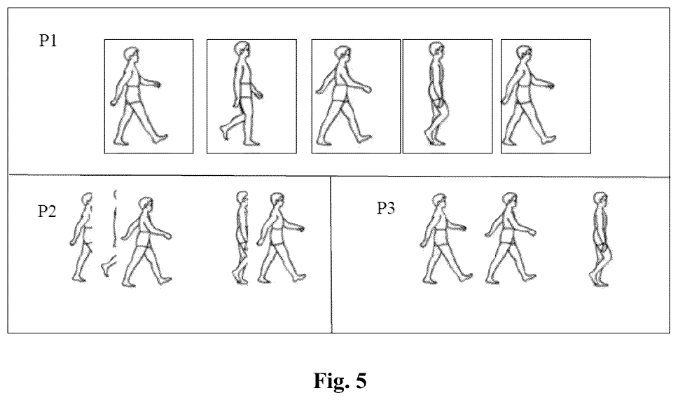

In order to better illustrate this situation, FIG. 5 is a schematic diagram showing a background image obtained through a step of pasting according to an embodiment of the present application. Referring to FIG. 5, P1 in FIG. 5 shows five sub-images which are clipped, P2 in FIG. 5 is an effect diagram obtained by pasting sub-images directly into a background image, and P3 is an effect diagram obtained by pasting sub-images which do not overlap into a background image. In P2, the plurality of sub-images overlap, and the display effect of the preset monitored target is poor; in P3, the sub-images which would overlap are not pasted in the background image, and the display effect of the preset monitored target is good.

In an alternative, the current pasting range of the sub-image to be pasted in the background image coincides with the range occupied by the sub-image to be pasted in the image to be processed. For example, if the bounding box coordinates of the sub-image to be pasted in the image to be processed are (0, 0) and (2, 2), the current pasting range of pasting of the sub-image to be pasted in the background image may be the scope corresponding to a rectangle having (0, 0), (2, 0), (0, 2) and (2, 2) as four vertices.

S135 Judge whether the current pasting range overlaps with a pasting range of a pasted sub-image in the background image; if the current pasting range does not overlap with the pasting range of the pasted sub-image in the background image, the process proceeds to S136.

If the current pasting range overlaps with the pasting range of the pasted sub-image in the background image, the sub-image to be pasted is not pasted at the current pasting range of the background image, and the process proceeds to S131 to continue to execute the pasting step on the next monitored image to be processed located after the current monitored image to be processed.

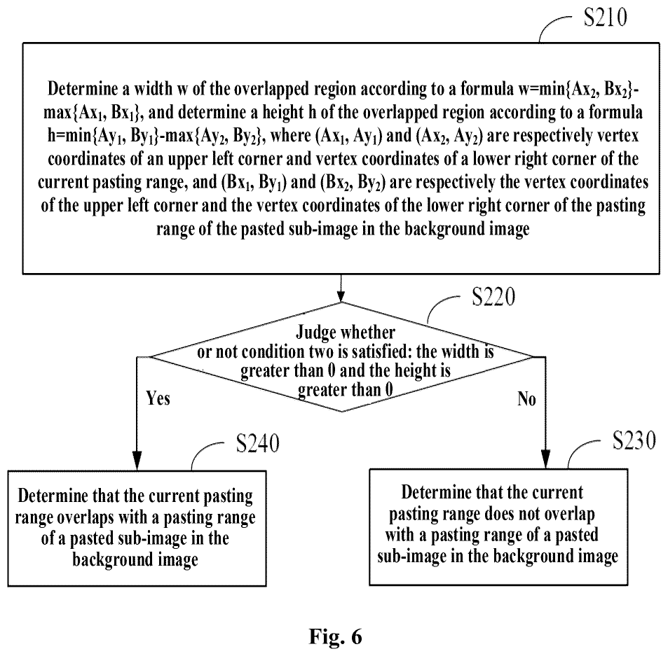

To judge whether the sub-image to be pasted and the pasted sub-image in the background image will overlap, in an alternative, both the current pasting range and the pasting range of the pasted sub-image in the background image are rectangular regions. In the case where a plurality of sub-images have been pasted in the background image, whether the sub-image to be pasted and each pasted sub-image will overlap is judged by the intersection determination step, respectively. FIG. 6 is a flow diagram showing an intersection determination step according to an embodiment of the present application, referring to FIG. 6. The intersection determination step includes:

S210 Determine a width w of the overlapped area according to a formula w=min {Ax₂, Bx₂}−max {Ax₁, Bx₁}, and determine a height h of the overlapped area according to a formula h=min {Ay₁, By₁}−max {Ay₂, By₂}, where (Ax₁, Ay₁) and (Ax₂, Ay₂) are respectively vertex coordinates of an upper left corner and vertex coordinates of a lower right corner of the current pasting range, and (Bx₁, By₁) and (Bx₂, By₂) are respectively the vertex coordinates of the upper left corner and the vertex coordinates of the lower right corner of the pasting range of the pasted sub-image in the background image.

In an alternative, a vertex coordinate at the top left corner of the sub-image to be pasted is designated as (Ax₁, Ay₁), and a vertex coordinate at the bottom right corner of the sub-image to be pasted is designated as (Ax₂, Ay₂); a top left vertex of the pasted sub-image is designated as (Bx₁, By₁) and a bottom right vertex of the pasted sub-image is designated as (Bx₂, By₂). The coordinates of the sub-image may be the coordinates of the bounding box of the preset monitored target located by the target recognition unit 15.

Assuming that the sub-image to be pasted coincides with the pasted sub-image, there is an overlapped region of the sub-image to be pasted and the pasted sub-image. In the formula w=min {Ax₂, Bx₂}−max {Ax₁, Bx₁}, min {Ax₂, Bx₂} represents taking the minimum number of elements from the set {Ax₂, Bx₂} as an x value of a vertex coordinate at a lower right corner of the overlapped region, and max {Ax₁, Bx₁} represents taking the maximum number of elements from the set {Ax₁, Bx₁} as an x value of a vertex coordinate at an upper left corner of the overlapped region. The difference between the x value of the vertex coordinate at the lower right corner and the x value of the vertex coordinate at the upper left corner of the overlapped region is taken as the width value w of the overlapped region.

In the formula h=min {Ay₁, By₁}−max {Ay₂, By₂}, min {Ay₁, By₁} represents the smallest number of elements from the set {Ay₁, By₁} taken as a y value of a vertex coordinate at a top left corner of the overlapped area, and max {Ay₂, By₂} represents the largest number of elements from the set max {Ay₂, By₂} taken as a y value of a vertex coordinate at a bottom right corner of the overlapped area. The overlapped region height value h is the difference between the y value of the top left vertex coordinate and the y value of the bottom right vertex coordinate of the overlapped region.

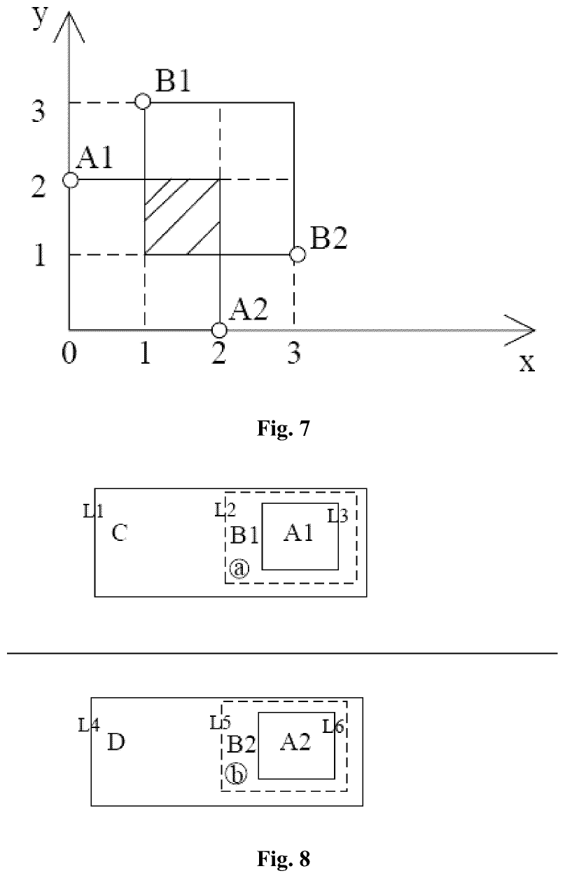

For example, FIG. 7 is a schematic diagram showing an overlapped region between a sub-image to be pasted and a pasted sub-image provided by an embodiment of the present application. Referring to FIG. 7, a coordinate of a vertex A1 at an upper left corner of the sub-image to be pasted is (x₁, y₁)=(0, 2), a coordinate of vertex A2 at a lower right corner of the sub-image to be pasted is (x₂, y₂)=(2, 0), a coordinate of a vertex B1 at an upper left corner of the pasted sub-image is (x₃, y₃)=(1, 3), and a coordinate of a vertex B2 at a lower right corner of the pasted sub-image is (x₄, y₄)=(3, 1), i.e., (Ax₁, Ay₁)=(0, 2), (Ax₂, Ay₂)=(2, 0), (Bx₁, By₁)=(1, 3), (Bx₂, By₂)=(3, 1). It can be seen that w=min {Ax₂, Bx₂}−max {Ax₁, Bx₁}−min {2, 3}−max {0, 1}=2−1=1; h=min {Ay₁, By₁}−max {Ay₂, By₂}=min {2, 3}−max {0, 1}=2−1=1, which is consistent with the length and width of the overlapped region represented by the shaded region in FIG. 7.

S220 Judge whether or not condition two is satisfied: the width is greater than 0 and the height is greater than 0; if the condition two is not satisfied, the process proceeds to S230; and if the condition two is satisfied, the process proceeds to S240.

If the condition two is not satisfied, the width is not greater than 0 or the height is not greater than 0; satisfaction of the condition two means that the width is greater than 0 and the height is greater than 0.

S230 Determine that the current pasting range does not overlap with the pasting range of the pasted sub-image in the background image.

S240 Determine that the current pasting range does not overlap with a pasting range of a pasted sub-image in the background image.

In S210, it is assumed that an overlapped region of the sub-image to be pasted and the pasted sub-image exists, and the width w of the overlapped region is determined by the formula w=min {Ax₂, Bx₂}−max {Ax₁, Bx₁}, and the height h of the overlapped region is determined according to the formula h=min {Ay₁, By₁}−max {Ay₂, By₂}. If the determined w and h are both greater than 0, it is verified that the overlapped region exists, that is to say, the sub-image to be pasted and the pasted sub-image will overlap; if it is determined that w is not greater than 0 or h is not greater than 0, this contradicts the number that both w and h are greater than 0, indicating that the assumption is wrong, i.e., the overlapped region does not exist, and the sub-image to be pasted and the pasted sub-image do not overlap.

Through S210 to S240, according to the vertex coordinate at the upper left corner and the vertex coordinate at the lower right corner of the sub-image to be pasted in the monitored image, and the vertex coordinate at the upper left corner and the vertex coordinate at the lower right corner of the pasted sub-image in the background image, a formula operation is performed, so as to judge whether there is an overlapped region in the x-axis and the y-axis of the sub-image to be pasted and the pasted sub-image, respectively. If there is an overlapped region in both the x-axis and the y-axis of the sub-image to be pasted and the pasted sub-image, it is indicated that the sub-image to be pasted and the pasted sub-image will overlap, and the above coordinate operation method can accurately determine whether the sub-image to be pasted will overlap with the pasted sub-image in the background image.

To determine whether the sub-image to be pasted and each pasted sub-image will overlap, in another alternative, the x-axis range may be first compared to check whether the projections on the x-axis of the sub-image to be pasted and the pasted sub-image intersect, and if Ax₂<Bx₁ or Ax₁>Bx₂, they do not intersect on the x-axis. Then, comparing the y-axis range, and checking whether the projections on the y-axis of the sub-image to be pasted and the pasted sub-image intersect, and if Ay₂<By₁ or Ay₁>By₂, they do not intersect on the y-axis; finally, if the sub-image to be pasted and the pasted sub-image intersect in both the x-axis and the y-axis, the sub-image to be pasted and the pasted sub-image overlap in a two-dimensional plane.

S136 Paste the sub-image to be pasted to a current pasting range of the background image.

In the background image, information about the capture time of the monitored image corresponding thereto can also be marked near the position of the pasted sub-image or the pasted sub-image, so that the moving track and moving time of the preset monitored target can be displayed in the background image at the same time.

S140 After performing the pasting step on the plurality of monitored images to be processed, determine the obtained background image as an image required to be generated.

The background image obtained in S140 may be the background image as shown in P3 in FIG. 5, instead of the background image as shown in P2 in FIG. 5.

The embodiment of the present application determines the current pasting range of the sub-image to be pasted in the background image according to the size of the sub-image to be pasted and the position in the monitored image to be processed, so that the background image (namely, an alarm event paste) obtained after executing the pasting step displays the same preset monitored target at different positions, and a moving track of the preset monitored target can be indicated, thereby enabling a user to learn preset monitored target information including the preset monitored target and the moving track thereof in a monitored region via the alarm event paste; since such preset monitored target information essentially contains information that the preset monitored target is within a certain period of time rather than at a certain moment, the user can completely know the preset monitored target information of the alarm event. By browsing one alarm event paste, the complete preset monitored target information can be known, the browsing time is reduced, and the fast browsing can be achieved.

In addition, before the sub-image to be pasted is pasted to the background image, the current pasting range of the sub-image to be pasted in the background image is determined according to the position of the sub-image to be pasted in the monitored image to be processed and the size of the sub-image to be pasted, and the sub-image to be pasted is pasted only in the case where the current pasting range does not overlap with the pasting range of the pasted sub-image in the background image, so as to avoid the case where the pasting causes confusion of the display of the preset monitored target when the sub-images overlap, and if the display is confused, the user will not be able to quickly and completely browse the preset monitored target information of the alarm event.

When a plurality of preset monitored targets simultaneously appear in the monitored region, a monitored image to be processed may contain a plurality of preset monitored targets. In an alternative, a plurality of sub-images containing different preset monitored targets can be obtained by intercepting a monitored image to be processed, and a plurality of sub-images corresponding to a monitored image to be processed can be attached to the same background image.

In another preferred implementation, only certain preset monitored targets may be intercepted at each interception, for example, if one person and one cat are included in the monitored image to be processed, only the sub-image including the person may be intercepted, and the sub-images including the person in the plurality of monitored images to be processed may be attached to the same background image, and then the sub-image including the cat may be intercepted, and the sub-images including the cat in the plurality of monitored images to be processed may be attached to another background image, so that each background image only includes a moving track of one preset monitored target.

Specifically, when at least one monitored image in a plurality of monitored images contains a plurality of preset monitored targets, S130 includes: S130a Perform the pasting step on each monitored image to be processed containing the same preset monitored target of the plurality of monitored images to be processed successively according to the time sequence of the monitored images to be processed.

When a target recognition algorithm recognizes a plurality of time-continuous monitored images, if one of the monitored images (image 1) contains a preset monitored target, the target recognition algorithm generates a target identifier of the preset monitored target and stores same; in a subsequent monitored image, if images 2 and 3 in the subsequent monitored image contain the preset monitored target, the target recognition algorithm generates a target identifier of the preset monitored target of image 2 and a target identifier of the preset monitored target of image 3, and matches same with the stored target identifier; if the target identifiers of the preset monitored targets of the image 2 and the image 3 are successfully matched with the target identifier of the preset monitored target of the image 1, it means that the image 1, the image 2 and the image 3 contain the same preset monitored target.

S131 includes: S131a Intercept a region containing a same preset monitored target in a monitored image to be processed as a sub-image to be pasted.

In an alternative, a region in which a sub-image containing a preset monitored target corresponding to the same target identifier is located in a monitored image to be processed is intercepted to determine the sub-image to be pasted.

When a plurality of preset monitored targets appear in the monitored region, if the plurality of targets are all pasted in the same background image, the pasting will not be performed in S123 due to easy overlapping; if the pasting will not be performed due to the overlapping sub-images of different preset monitored targets, the target track will be lost in the background image, so that the track of a single preset monitored target in the background image is not so complete.

Therefore, through S130a and S131a, the sub-images to be pasted containing the same preset monitored target are clipped from the monitored images containing the same preset monitored target, and the sub-images to be pasted containing the same preset monitored target are pasted into a background image, so that each background image only contains the sub-images of a single preset monitored target, and no pasting is performed due to the overlapping sub-images of different preset monitored targets when pasting, which can improve the integrity of the track of a single preset monitored target in the background image, and help a user to understand and analyze the moving track and behavior intention of a single preset monitored target more easily through the background image.

When the sub-image is pasted into the background image, the sub-image layer and the background image layer are easy to be obviously layered. In order to make a good transition between the edges of the sub-image and the background image, after S136, in an alternative, S130 further includes the following sub-steps:

S155 Determine a first peripheral region of the sub-image to be pasted in the monitored image to be processed, and determine a first pixel value of the first peripheral region in the monitored image to be processed, where the first peripheral region is an extended region outside a boundary of the sub-image to be pasted.

S156 Determine a second peripheral region of the sub-image to be pasted in the background image, and determining a second pixel value of the second peripheral region in the background image, where the second peripheral region is the extended region outside the boundary of the sub-image to be pasted, and a shape and a size of the first peripheral region and the second peripheral region are the same.

FIG. 8 is a schematic diagram showing a first outer peripheral region and a second outer peripheral region according to an embodiment of the present application, referring to FIG. 8. In FIG. 8, a C region (a rectangular region enclosed by a solid line L1) is a region corresponding to a monitored image to be processed, an A1 region (a rectangular region enclosed by a solid line L3) is a region corresponding to a sub-image to be pasted which contains a preset monitored target in the monitored image to be processed, an A2 region (a rectangular region enclosed by a solid line L6) is a region corresponding to a pasting range of the sub-image to be pasted in a background image, and a D region (a rectangular region enclosed by a solid line L4) is a region corresponding to the background image.

The region obtained by subtracting the A1 region from the dashed box corresponding to the dashed line L2 in FIG. 8 is a first peripheral region, that is, the B1 region as shown in FIG. 8; the region obtained by subtracting the A2 region from the dashed box corresponding to the dashed line L5 in FIG. 8 is the second outer peripheral region, i.e., the B2 region as shown in FIG. 8, where the size of the dashed box can be determined as follows: the smaller of the length value and the width value of the sub-image to be pasted (A1 region or A2 region) is multiplied by a coefficient of 0.1 to obtain a value, and this value is respectively added to the length value and the width value of the A1 region to obtain the length value and the width value of the dotted box; it is also possible to multiply the smaller of the length value and the width value of the sub-image to be pasted (A1 region or A2 region) by a factor of 1.1 to obtain the length value and the width value of the dashed box. The central position of the dashed box corresponding to the A1 region in FIG. 8 may coincide with the central position of the A1 region, and the central position of the dashed box corresponding to the A2 region in FIG. 8 may coincide with the central position of the A2 region.

In an alternative, the first pixel value of the first peripheral region in the monitored image to be processed includes pixel values of a plurality of pixel points within the first peripheral region; the second pixel values of the second peripheral region in the background image include pixel values of a plurality of pixel points within the second peripheral region, and the plurality of pixel points of the first peripheral region correspond to the plurality of pixel points of the second peripheral region on a one-to-one basis.

S157 Determine a third pixel value according to the first pixel value and the second pixel value.

In an alternative, the third pixel value of each pixel point of the second peripheral region is a sum of the first pixel value and the second pixel value corresponding thereto.

S158 Fill the second peripheral region with the third pixel value.

The pixel value of each pixel point of the second peripheral region is modified from the original second pixel value to a third pixel value corresponding to the pixel point.

According to the embodiment of the present application, a second peripheral region is added to the background image through S155 to S158, and the pixel value of the second peripheral region is set as a third pixel value, so that the second peripheral region filled with the third pixel value can be used as a color transition region between the sub-image and the background image in the background image, and the sub-image and the background image in the background image perform color transition through the third pixel value of the color transition region, so as to alleviate the problem of layering between the sub-image and the background image.

In order to improve the operating efficiency of the camera device 1 when adding a color transition region between the sub-image and the background image in the background image, in an alternative, S155 includes the following sub-steps:

S155a Determine the first peripheral region of the sub-image to be pasted in the monitored image to be processed, and randomly select a first color taking point in the first peripheral region.

Any one pixel point in the first peripheral region is taken as the first color taking point, as shown in FIG. 8, point a is the first color taking point.

S155b Determine a pixel value of the first color taking point as the first pixel value.

The first pixel value of the first peripheral region B1 can be quickly determined by taking the pixel value of the first color taking point a as the first pixel value.

S156 includes the following sub-steps:

S156a Determine the second peripheral region of the sub-image to be pasted in the background image, and select a second color taking point in the second peripheral region according to the position of the first color taking point in the first peripheral region.

According to the position of the first color taking point in the first peripheral region, a pixel point is selected as a second color taking point in the second peripheral region, and as shown in FIG. 8, point b is the second color taking point.

S156b Determine the pixel value of the second color taking point as a second pixel value.

The second pixel value of the second peripheral region B2 can be quickly determined by taking the pixel value of the second color taking point b as the second pixel value.

Through S155a to S156b, the third pixel value of each pixel point in the second peripheral region can be quickly calculated by taking the pixel value of one pixel point in the first peripheral region as the first pixel value of the first peripheral region and taking the pixel value of one pixel point in the second peripheral region as the second pixel value of the second peripheral region, as compared to separately determining the pixel value of each point in the first peripheral region and the second peripheral region, so as to quickly establish the color transition region with the sub-image in the background image.

Further, in order to improve the transition effect of the color transition region, the third pixel value of the pixel point may be determined according to the distance between the pixel point in the second outer peripheral region and the sub-image (A2 region), and specifically, S157 includes the following sub-steps:

S157a Determine a first weighted value and a second weighted value of each pixel point in the second peripheral region according to a distance value from the each pixel point to the boundary of the sub-image to be pasted, where the first weighted value of the each pixel point is negatively correlated with the second weighted value, and the first weighted value of the each pixel point is negatively correlated with the distance value.

In an alternative, the first weighted value is set to be (1−α), and the second weighted value is set to be α, where α∈[0,1], and when a distance value between a pixel in region B2 and region A2 decreases, the α value of that pixel in the region B2 also decreases.

S157b Determine a sum value between a product of the first weighted value and the first pixel value and a product of the second weighted value and the second pixel value of each pixel point as a third pixel value of each pixel point.

In an alternative, the third pixel value for each pixel point in B2 is calculated by the formula p₃=(1−α)*p₁+α*p₂, where p₃ is the third pixel value for each pixel point in B2, 1−α is the first weighted value for the pixel point in B2, α is the second weighted value for the pixel point in B2, p₁ is the pixel value for point a in B1, and p₂ is the pixel value for point b in B2.

S158 includes: S158a Fill each pixel point in the second peripheral region in the background image with the third pixel value of the each pixel point.

According to the embodiment of the present application, a sum value between the product of the first weighted value and the first pixel value and the product of the second weighted value and the second pixel value of each pixel point in the color transition region is determined as the third pixel value of each pixel point through steps S157a and S158a, and the first weighted value and the second weighted value of each pixel point are negatively correlated, and the first weighted value and the distance value of each pixel point are negatively correlated, so that when the pixel point in the color transition region is closer to the background image, the pixel value thereof is close to the pixel value of the background image, and when the pixel point in the transition layer is closer to the ion image, the pixel values thereof are close to the pixel values of the sub-image, thereby improving the color transition effect of the color transition region.

The embodiments of the present application provide a computer-readable storage medium that stores a computer program that, when executed by a processor, performs the steps in the above-described image generation method embodiments.

The embodiments of the present application provide a computer program that is executable by a processor to implement the steps in the above-described image generation method embodiments.

The embodiments of the present application provide a computer program product including a computer program which, when executed by a processor, carries out the steps of the above-described embodiments of the image generation method.

The algorithms or displays presented herein are not inherently related to any particular computer, virtual system, or other devices. Various general purpose systems may also be used with the teachings based herein. The structure required to construct such a system is apparent from the above description. Further, the embodiments of the present application are not directed to any particular programming language. It should be understood that the subject matter described herein may be implemented using a variety of programming languages and that the description above of specific languages is for an objective of disclosing the best mode of practicing the subject matter.

In the description provided herein, numerous specific details are set forth. However, it is understood that embodiments of the present application may be practiced without these specific details. In some instances, well-known methods, structures and techniques have not been shown in detail in order not to obscure the understanding of this description.

Similarly, it should be appreciated that in the above description of example embodiments of the present application, various features of the embodiments of the present application are sometimes grouped together in a single embodiment, figure, or description thereof for the purpose of streamlining the present application and aiding in the understanding of one or more of the various inventive aspects. However, the disclosed method should not be construed as reflecting an intention that the claimed invention requires more features than those explicitly recited in each claim.

It will be appreciated by a person skilled in the art that the modules in the devices in an embodiment may be adapted and arranged in one or more devices different from the embodiment. Modules or units or components in an embodiment may be combined into one module or unit or component, and they may be divided into a plurality of sub-modules or sub-units or sub-components. All of the features disclosed in this description (including any accompanying claims, abstract and drawings), and all of the processes or elements of any method or device so disclosed, may be combined in any combination, except combinations where at least some of such features and/or processes or elements are mutually exclusive. Each feature disclosed in the present description (including any accompanying claims, abstract and drawings), may be replaced by alternative features serving the same, equivalent or similar purpose, unless expressly stated otherwise.

It should be noted that the above-mentioned embodiments illustrate rather than limit the present application, and that a person skilled in the art will be able to design alternative embodiments without departing from the scope of the appended claims. In the claims, any reference signs placed between parentheses shall not be construed as limiting the claim. The word “including” does not exclude the presence of elements or steps other than those listed in a claim. The word “a” or “an” preceding an element does not exclude the presence of a plurality of such elements. The present application can be implemented by means of hardware including several distinct elements, and by means of a suitably programmed computer. In the unit claims enumerating several means, several of these means can be embodied by one and the same item of hardware. The use of the words first, second, third, etc. does not denote any order. These words may be interpreted as names. The steps in the above-described embodiments, unless otherwise specified, should not be construed as limiting the order of execution.

What is claim is:

1. An image generation method, comprising:
acquiring a background image and a plurality of monitored images, each of the plurality of monitored images comprising a monitored target;
obtaining a plurality of sub-images based on a region in each of the plurality of monitored images, the region comprising the monitored target being a portion of each of the monitored images; and
generating an image by putting at least two of the plurality of sub-images in the background image in a chronological order.

2. The method according to claim 1, further comprising:
determining the at least two of the plurality of sub-images to be put in the background image based on overlaps between the plurality of sub-images.

3. The method according to claim 2, further comprising:
determining a range of the sub-image to be put in the background image according to a position of the sub-image in the monitored image and a size of the sub-image;
judging whether the range overlaps with a pasting range of a pasted sub-image in the background image;
pasting the sub-image to be pasted to the current pasting range of the background image if the current pasting range does not overlap with the pasting range of the pasted sub-image in the background image; and
determining the obtained background image as an image required to be generated.

4. The method according to claim 3, wherein the pasting the sub-image to be pasted to the current pasting range of the background image, comprises:
determining a first peripheral region of the sub-image to be pasted in the monitored image to be processed, and determining a first pixel value of the first peripheral region in the monitored image to be processed, wherein the first peripheral region is an extended region outside a boundary of the sub-image to be pasted;
determining a second peripheral region of the sub-image to be pasted in the background image, and determining a second pixel value of the second peripheral region in the background image, wherein the second peripheral region is the extended region outside the boundary of the sub-image to be pasted, and a shape and a size of the first peripheral region and the second peripheral region are the same;
determining a third pixel value according to the first pixel value and the second pixel value; and
filling the second peripheral region with the third pixel value.

5. The method according to claim 4, wherein the determining a first peripheral region of the sub-image to be pasted in the monitored image to be processed, and determining a first pixel value of the first peripheral region in the monitored image to be processed comprises:
determining the first peripheral region of the sub-image to be pasted in the monitored image to be processed, and randomly selecting a first color taking point in the first peripheral region;
determining a pixel value of the first color taking point as the first pixel value;
wherein the determining a second peripheral region of the sub-image to be pasted in the background image, and determining a second pixel value of the second peripheral region in the background image comprises:
determining the second peripheral region of the sub-image to be pasted in the background image, and selecting a second color taking point in the second peripheral region according to the position of the first color taking point in the first peripheral region; and
determining a pixel value of the second color taking point as the second pixel value.

6. The method according to claim 5, wherein the determining a third pixel value according to the first pixel value and the second pixel value comprises:
determining a first weighted value and a second weighted value of each pixel point according to a distance value from the each pixel point in the second peripheral region to the boundary of the sub-image to be pasted, wherein the first weighted value is negatively correlated with the second weighted value of the each pixel point, and the first weighted value of the each pixel point is negatively correlated with the distance value;
determining a sum value between a product of the first weighted value and the first pixel value and a product of the second weighted value and the second pixel value of each pixel point as a third pixel value of each pixel point;
wherein the filling the second peripheral region with the third pixel value comprises:
filling each pixel point in the second peripheral region in the background image with the third pixel value of each pixel point.

7. The method according to claim 3, wherein the judging whether the current pasting range overlaps with a pasting range of a pasted sub-image in the background image comprises:
determining a width w of the overlapped region according to a formula w=min {Ax₂, Bx₂}−max {Ax₁, Bx₁}, and determining a height h of the overlapped region according to a formula h=min {Ay₁, By₁}−max {Ay₂, By₂}, wherein (Ax₁, Ay₁) and (Ax₂, Ay₂) are respectively vertex coordinates of an upper left corner and vertex coordinates of a lower right corner of the current pasting range, and (Bx₁, By₁) and (Bx₂, By₂) are respectively the vertex coordinates of the upper left corner and the vertex coordinates of the lower right corner of the pasting range of the pasted sub-image in the background image;
judging whether the width is greater than 0 and whether the height is greater than 0;
if the width is not greater than 0 or the height is not greater than 0, determining that the current pasting range does not overlap with the pasting range of the pasted sub-image in the background image; and
if the width is greater than 0 and the height is greater than 0, determining that the current pasting range overlaps with the pasting range of the pasted sub-image in the background image.

8. The method according to claim 1, wherein if at least one monitored image of the plurality of monitored images comprises a plurality of preset monitored targets, the step of performing a pasting step on the plurality of monitored images to be processed successively according to the time sequence of the monitored images to be processed comprises:
performing the pasting step on each monitored image to be processed comprising the same preset monitored target of the plurality of monitored images to be processed successively according to the time sequence of the monitored images to be processed;
the intercepting a region comprising the preset monitored target in the monitored image to be processed as a sub-image to be pasted comprises:
intercepting a region comprising a same preset monitored target in the monitored image to be processed as a sub-image to be pasted.

9. The method according to claim 1, wherein the acquiring a background image and a plurality of monitored images arranged by a time sequence comprises:
in response to recognizing the preset monitored target appearing in the monitored region, acquiring the plurality of monitored images continuously captured with respect to the monitored region within a preset time period, and acquiring the background image; or,
in response to recognizing the preset monitored target appearing in the monitored region, acquiring a plurality of monitored images from a time period when the preset monitored target appearing in the monitored region to when the preset monitored target disappears from the monitored region, and acquiring the background image.

10. The method according to claim 1, wherein the acquiring a background image and a plurality of monitored images arranged by a time sequence comprises:
acquiring the plurality of monitored images arranged by the time sequence; and
converting one monitored image of the plurality of monitored images from an RGB color space to a YUV color space, and determining the converted image as the background image.

11. A camera device, comprising a memory, a processor and a computer program stored on the memory, wherein the processor executes the computer program to:
acquire a background image and a plurality of monitored images, each of the monitored images comprising a monitored target;
obtain a plurality of sub-images based on a region in each of the plurality of monitored images, the region comprising the monitored target being a portion of each of the monitored images; and
generating an image by putting at least two of the plurality of sub-images in the background image in a chronological order.

12. The camera device according to claim 11, wherein the processor further executes the computer program to determine the at least two of the plurality of sub-images to be put in the background image based on overlaps between the plurality of sub-images.

13. The camera device according to claim 12, wherein the processor further executes the computer program to:
determine a range of the sub-image to be put in the background image according to a position of the sub-image in the monitored image and a size of the sub-image;
judge whether the range overlaps with a pasting range of a pasted sub-image in the background image;
past the sub-image to the current pasting range of the background image, if the current pasting range does not overlap with the pasting range of the pasted sub-image in the background image; and
determine the obtained background image as an image required to be generated.

14. The camera device according to claim 13, wherein the processor further executes the computer program to:
determining a first peripheral region of the sub-image to be pasted in the monitored image to be processed, and determining a first pixel value of the first peripheral region in the monitored image to be processed, wherein the first peripheral region is an extended region outside a boundary of the sub-image to be pasted;
determine a second peripheral region of the sub-image to be pasted in the background image, and determining a second pixel value of the second peripheral region in the background image, wherein the second peripheral region is the extended region outside the boundary of the sub-image to be pasted, and a shape and a size of the first peripheral region and the second peripheral region are the same;
determine a third pixel value according to the first pixel value and the second pixel value; and
fill the second peripheral region with the third pixel value.

15. The camera device according to claim 14, wherein the processor further executes the computer program to:
determine the first peripheral region of the sub-image to be pasted in the monitored image to be processed, and randomly selecting a first color taking point in the first peripheral region;
determine a pixel value of the first color taking point as the first pixel value;
determine the second peripheral region of the sub-image to be pasted in the background image, and select a second color taking point in the second peripheral region according to the position of the first color taking point in the first peripheral region; and
determine a pixel value of the second color taking point as the second pixel value.

16. The camera device according to claim 15, wherein the processor further executes the computer program to:
determine a first weighted value and a second weighted value of each pixel point according to a distance value from each pixel point in the second peripheral region to the boundary of the sub-image to be pasted, wherein the first weighted value is negatively correlated with the second weighted value of each pixel point, and the first weighted value of each pixel point is negatively correlated with the distance value;
determine a sum value between a product of the first weighted value and the first pixel value and a product of the second weighted value and the second pixel value of each pixel point as a third pixel value of each pixel point; and
fill each pixel point in the second peripheral region in the background image with the third pixel value of each pixel point.

17. The camera device according to claim 13, wherein the processor further executes the computer program to:
determine a width w of the overlapped region according to a formula w=min {Ax₂, Bx₂}−max {Ax₁, Bx₁}, and determine a height h of the overlapped region according to a formula h=min {Ay₁, By₁}−max {Ay₂, By₂}, wherein (Ax₁, Ay₁) and (Ax₂, Ay₂) are respectively vertex coordinates of an upper left corner and vertex coordinates of a lower right corner of the current pasting range, and (Bx₁, By₁) and (Bx₂, By₂) are respectively the vertex coordinates of the upper left corner and the vertex coordinates of the lower right corner of the pasting range of the pasted sub-image in the background image;
judge whether the width is greater than 0 and whether the height is greater than 0;
determine that the current pasting range does not overlap with the pasting range of the pasted sub-image in the background image, if the width is not greater than 0 or the height is not greater than 0; and
determine that the current pasting range overlaps with the pasting range of the pasted sub-image in the background image, if the width is greater than 0 and the height is greater than 0.

18. The camera device according to claim 11, wherein the processor further executes the computer program to:
in response to recognizing the preset monitored target appearing in the monitored region, acquire the plurality of monitored images continuously captured with respect to the monitored region within a preset time period, and acquiring the background image; or
in response to recognizing the preset monitored target appearing in the monitored region, acquiring a plurality of monitored images from a time period when the preset monitored target appearing in the monitored region to when the preset monitored target disappears from the monitored region, and acquiring the background image.

19. The camera device according to claim 11, wherein the processor further executes the computer program to:
acquire the plurality of monitored images arranged by the time sequence; and
convert one monitored image of the plurality of monitored images from an RGB color space to a YUV color space, and determining the converted image as the background image.

20. A non-transitory computer-readable storage medium having stored thereon a computer program, wherein the computer program, when executed by a processor, implements the image generation method according to claim 1.
